(19) United States
(12) Patent Application Publication
(10) Pub. No.: US 2017/0136427 A1
(43) Pub. Date: May 18, 2017

(54) Rapid High Solids Separation

(71) Applicant: Highland Fluid Technology, Ltd., Houston, TX (US)

(72) Inventor: Kevin W. Smith, Bellaire, TX (US)

(21) Appl. No.: 15/349,422

(22) Filed: Nov. 11, 2016

Related U.S. Application Data
(60) Provisional application No. 62/254,273, filed on Nov. 12, 2015.

(51) Int. Cl. B01F 11/02; B01D 21/01; C02F 1/56; E21B 43/34; B01D 37/02; C02F 1/38; B01F 7/00; E21B 21/06; B01D 21/26; C02F 1/00

(52) U.S. Cl. CPC B01F 11/0283; B01D 21/262; B01D 21/01; C02F 1/56; C02F 1/001; B01D 37/02; C02F 1/385; B01F 7/0075; E21B 21/065; E21B 43/34; C02F 2103/10

(57) ABSTRACT

A method and apparatus for removing and separating solids from liquid that may include passing a fluid containing particulate solids through a cavitation device that mixes and efficiently heats the fluid, together with a dry or partially dissolved flocculant, or a coagulant, a surfactant, a filter aid, or any combination thereof, and then to a solids separating device. Cavitation can be generated by passing the fluid through a constricted area between a moving cylindrical rotor containing cavities.

### CROSS-REFERENCE TO RELATED APPLICATIONS

This Application claims the benefit of U.S. Provisional Application No. 62/254,273, filed Nov. 12, 2015, and entitled Rapid High Solids Separation, which is hereby incorporated by reference it its entirety.

### TECHNICAL FIELD

The separation of solids from water-containing fluids is performed with a minimum of steps and equipment, saving time and money, by passing a fluid containing high solids through a cavitation device that generates heat together with water-soluble polymeric flocculants, inorganic coagulants, surface active agents, filter aids, or any combination of them, and then to a solids separator without the need for flocculant preparation tanks and other expensive and time-consuming equipment. The process can be used very effectively for any fluid containing solids, including fluids with high solids content such as mine tailings, sewage, industrial waste, used drilling muds and other oil field fluids.

### BACKGROUND OF THE INVENTION

Typically, the separation of solids from liquids, in waste water treatment, sewage treatment, and other contaminated liquids such as used well drilling fluid (oil-based or water based), fluids containing materials known in the bitumen mining industry as fine clay solids, or mine ore waste still containing residual values, involves the use of coagulants and/or flocculants forming particles that are separated by settling in large tanks or that otherwise require extended time and expensive equipment. Flocculation with polymers can be very efficient, but a common preparation for the process requires aging a solution of perhaps 0.25 to 3% polymer by weight to assure that it is fully relaxed and hydrated. The solution must be not only mixed but aged, usually in a large tank; this is especially problematic in a working oil field where there are many other production matters to address. One approach in the prior art to reduce the time involved and the equipment needed is described in Adams et al U.S. Pat. No. 7,338,608 and its related U.S. Pat. No. 7,381,332 to Pena et al, describing the use of undissolved polymers having an average discrete phase particle size of less than about 10 microns, carried in a water-in-oil emulsion, for mixing with an oil-based used drilling mud to facilitate solids-liquid separation. Again, the emulsified treating agent must be prepared in advance of the process. Moreover, even with very small polymer particles, the important mixing step, using more or less conventional mixing apparatus, may not be adequate to fully hydrolyze or dissolve the polymer and, depending on the kind of mixer employed, may risk damaging the polymers. Many other processes using water-soluble polymers require special mixing or dissolving equipment as well as settling tanks, and are quite time-dependent. A more efficient way of separating solids from liquids, particularly liquids containing high concentrations of solids, and, more particularly, difficult to handle fluids such as fluid fine tailings, and such as used well drilling fluids containing solids and other constituents, is needed.

### BRIEF SUMMARY OF THE INVENTION

I pass a fluid containing particulate solids through a cavitation device that mixes and efficiently heats the fluid, together with a dry or partially dissolved flocculant, or a coagulant, a surfactant, a filter aid, or any combination thereof, and then to a solids separating device. Cavitation in the devices I use is generated by passing the fluid through a constricted area between a moving cylindrical rotor containing cavities and the substantially concentric interior surface of a housing.

The flocculants may be any of the well-known water-soluble anionic, cationic, or nonionic polymeric flocculants such as polyacrylamide, various cellulose derivatives such as hydroxyethylcellulose (HEC) carboxymethylhydroxyethylcellulose (CMHEC), natural organic polymers such as guar gum, xanthan gum and their derivatives, polymers and copolymers of 2-acrylamido-2-propane sulfonic acid (AMPS) or dimethyl diallyl ammonium chloride (DMDAAC) cationic polymers or copolymers, polyethyleneimine, various other modified polyacrylates and acrylamide copolymers, and the like. They may be either in dry or partially hydrated or partially or completely dissolved form. Coagulants are typically inorganic, such as ferric chloride or alum and may be either in dry or dissolved form. The coagulants and polymers may be fed directly to the cavitation device in solid form, without previous dissolution. If the polymers and/or coagulants are used in partially dissolved or partially hydrated form, they may be at least partially hydrated or dissolved in a separate cavitation device similar to the one to which the fluid to be treated is fed; thus two cavitation devices are connected in series.

The cavitation device is so efficient at mixing the polymers and coagulants, and other solids/liquid separating agents into the fluid that additional solvent (water) is not needed, so long as the treated fluid contains at least 5% water. Dry polymeric flocculants will be hydrated by water present in the fluid. That is, the product provided by the cavitation device is already in an advanced state of coagulation and flocculation or other conditioning when it emerges from the cavitation device together with the treated fluid, so that the usual large settling tanks for the flocculated solids are not necessary, although they may be used if desired. The product may be passed directly from the cavitation device to a solids/liquid separator such as a centrifuge, hydrocyclone, vacuum filter box, filter press, an inclined plate separator, or one or more filters and screens of various types to carry out the complete solids removal. Of course it is possible to utilize a settling tank as a solids/liquid separator but a major advantage of the invention is its ability to obviate the expense and time consumed by settling tanks.

In addition to, or instead of a flocculant or a coagulant, I may introduce a surfactant chosen to render the solid particles more hydrophilic—that is, water wet—which will aid in some forms of solids/liquid separation. Likewise, the cavitation device is excellent for mixing filter aids (for example, certain nano fibers) into difficult solids-containing fluids, to enhance the efficiency of filtration.

Thus, although it is contemplated that the invention will most commonly use polymeric flocculants, it is useful for rapidly and intimately integrating any agent into a solids-containing fluid for enhancing or augmenting solids/liquid separation in a solids/liquid separation device such as a hydrocyclone, a centrifuge, filter, inclined plate separator, or settling tank. I include all such agents in the term “solids/liquid separation enhancing agent.” Flocculants, coagulants, surfactants, and filter aids are all included in this term.

Unlike many other mixers, a cavitation device is able to handle fluids having a very high content of solids (up to 50% by weight) whose particle size may be as large as ¼ inch. Moreover, the extreme turbulence generated within it will hydrate the polymers, activate the coagulants, disperse the surfactants, and thoroughly distribute the filter aids. It is thus frequently not necessary to have more than one pass through the device before going directly to a centrifuge or other separator. The cavitation devices I use will be further described in the Detailed Description of the Invention.

### BRIEF DESCRIPTION OF THE DRAWINGS

FIG. 1 is a partly sectional view of a flow-directed cavitation device used in my method.

FIG. 2 is a simplified flow sheet showing the integration of a flow-directed cavitation device of FIG. 1 into a system for removing solids from fluids containing them.

FIG. 3 illustrates a way of connecting two cavitation devices in series to feed a fluid containing coagulated and flocculated solids to a solids/liquid separator.

FIG. 4 is a flow diagram including a control system for the process.

### DETAILED DESCRIPTION OF THE INVENTION

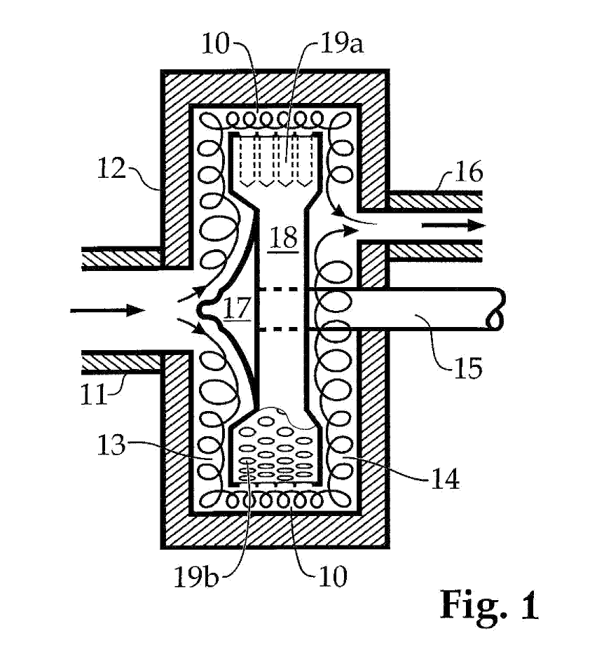

Referring now to FIG. 1, the flow-directed cavitation device is seen to include a cavitation rotor 18 within a housing 12. The cylindrical surface of cavitation rotor 18 has a large number of cavities in it, illustrated by their sections (19a) and their openings (19b), which may be referred to as cavities 19. Housing 12 has a cylindrical internal surface substantially concentric with cavitation rotor 18. Cavitation rotor 18 is mounted on shaft 15, which is turned by a motor not shown. Fluid containing solids to be separated enters, together with a coagulant, flocculant, or other solids/liquid separation enhancing agent, through inlet 11 and immediately encounters flow director 17 which evenly spreads the fluid ingredients radially over the spinning flow director, and imparts significant turbulence to it, as indicated by the spiral arrows. As the fluid enters the space 10 between cavities 19 and the conforming cylindrical internal surface of housing 12, it is subjected to cavitation—that is, it tends to fall into cavities 19 but is immediately ejected from them by centrifugal force, which causes a partial vacuum in the cavities; the vacuum is immediately filled, accompanied by the generation of heat and violent motion in and around the cavities 19. This highly turbulent action in the cavitation zone between the two cylindrical surfaces of the cavitation device thoroughly mixes and heats the materials but also, of special interest in the present invention, because of the intimate mixing and contacting of the coagulants, polymeric flocculants and water in the fluid, it activates the coagulants and flocculants; in particular, it hydrolyzes the water-soluble portions of the polymers and begins the process of flocculation inside the cavitation device. In this state, the fluid continues its turbulent flow (as indicated by the curled arrows in chamber 13, 14) to outlet 16 which leads to a solids/liquid separator not shown. If a polymer is introduced in a partially or completely hydrolyzed or dissolved state, it may be possible to increase the flow rate of the treated fluid through the cavitation device to obtain results more or less similar to those obtained if the polymer is introduced in the dry state. This will depend on many factors however, and the benefits of the invention may be realized by changing more than this variable within the discretion of the operator.

Persons skilled in the art will recognize that the intimate mixing effected by the cavitation device in a very short time will enhance the efficiency of any flocculant, coagulant, surfactant or filter aid in bringing about the ultimate separation desired. But also, the cavitation device's ability to impart heat directly to the fluid (with little or no risk of scale buildup or other undesirable side effects) will accelerate the hydration and dissolution of the polymeric flocculants so that they can act very quickly to flocculate the solids. An increase in temperature of even a few degrees will benefit the hydrolysis process.

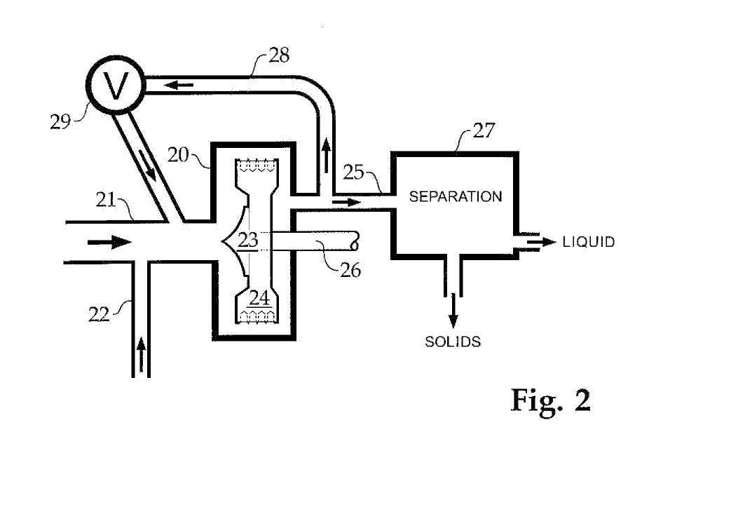

In FIG. 2, it is seen that both the fluid containing high solids and the coagulant, flocculant, or both, or any solids/liquid separation enhancing agent or combination, are fed from the same inlet into the flow-directed cavitation device described with respect to FIG. 1. The fluid to be treated, from a source not shown, enters the cavitation device 20 through inlet 21. As explained with respect to FIG. 1, flow-directed cavitation device 20 comprises a cavitation rotor 24 mounted on a shaft 26 turned by a motor not shown and having a tapering flow director 23 facing the incoming fluid. Conduit 22 carries coagulant or flocculant, or any solids/liquid separation enhancing agent either dry or with liquid as a carrier or solvent, from a source not shown to merge with the incoming fluid in inlet 21. The materials are thoroughly mixed and heated as they pass through flow-directed cavitation device 20 to outlet conduit 25. In outlet conduit 25, the solids are already at least partly coagulated and/or flocculated or otherwise treated and are ready for separation. Outlet conduit 25 directs the mixture to solids/liquid separation device 27, where the solids and liquid are separated.

Fluid in conduit 25 may be recycled, as by conduit 28. Recycling can be regulated by valve 29. It should be understood that the movement of fluid anywhere in my system is effected by appropriate pumps, valves and controls.

Solids/liquid separation device 27 may be any effective solids/liquid separator such as a centrifuge, hydrocyclone, vacuum filter box, filter press, an inclined plate separator, or any of various filters and screens.

Rotating cavitation devices are known in the art of mixing and heating, but have not been used for high speed activation of undissolved polymers or coagulants directly in fluids containing solids, to make a fluid already in an advanced stage of flocculation or coagulation, ready for a separation step and not needing time-consuming settling or the use of other expensive equipment ahead of what normally would be the final separation step in a complicated process. The device of FIGS. 1 and 2 is the subject of U.S. Provisional Patent Application 62/197,862 filed Jul. 28, 2015 and its successor nonprovisional application Ser. No. 15/221,878, titled Cavitation Device, filed Jul. 28, 2016, which are incorporated herein in their entirety. This application describes the device as “flow-directed” because it includes a flow director such as flow director 17 in FIG. 1 hereof, which is a somewhat flattened conical shape, the peak of the conical shape positioned centrally with respect to the device's fluid inlet so the incoming fluid will be spread and radiated evenly over its rotating surface. The central positioning of the flattened conical or bell-like surface is facilitated by the “overhung” design of the cavitation device wherein the shaft (15 in FIG. 1) passes through the outlet side of the device's housing but not the inlet side. The exemplary cavitation device of FIGS. 1 and 2 hereof generates its highly enhanced mixing effect because of the somewhat flattened conical or campanulate flow directors 17 (FIG. 1) and 23 (FIG. 2) facing into the incoming fluid. Flow directors 17 and 23 have a somewhat flattened bell-shaped profile, but it should be understood that they may assume different profile shapes such as parabolic, elliptical, hyperbolic or others not so mathematically regular, as long as it is high in the center where the fluid enters. For example, it could have a steeper profile, but when treating used drilling fluid, a sharper apex may be more subject to instability and erosion. The tapering extremity (as shown in profile) may extend more or less asymptotically to the outer edge of rotor 18 or 24, but this may not be necessary for improved mixing and may mean a less efficient heat transfer from the body of the rotor 18 (FIG. 1) or 24 (FIG. 2). Flow directors 17 and 23 may include channels, ridges, and the like to cause more turbulence or to enhance the effect of centrifugal force tending to fling the fluid toward space 10.

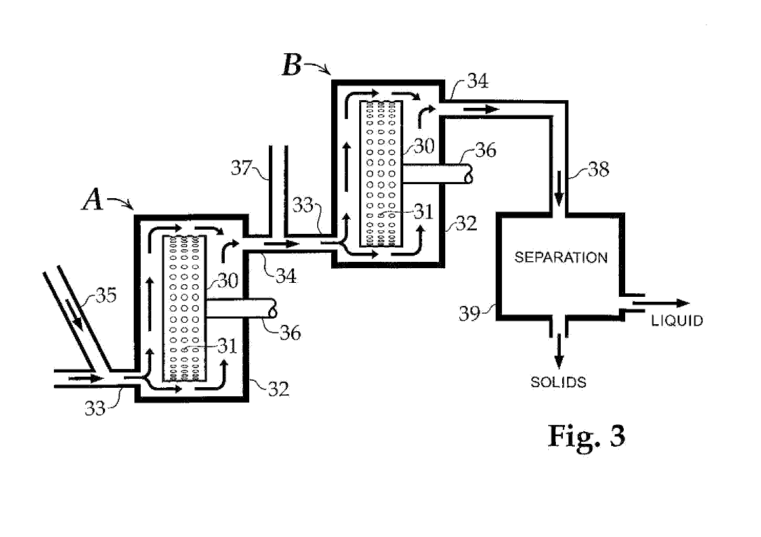

It should be understood that by a flow-directed cavitation device is meant a cavitation device comprising a rotor including a plurality of cavities on its cylindrical surface, the rotor being within a housing having a conforming cylindrical surface sized to form a cavitation zone, the rotor including a flow director having an apex facing into the incoming fluid. But, as will be seen in FIG. 3, it is not necessary to include a flow director such as flow director 17 or 23 to practice my invention.

Referring now to FIG. 3, it is seen that the invention contemplates two cavitation devices A and B connected in series. Each cavitation device A and B has a rotor 30 having cavities 31 similar to cavities 19 in FIG. 1. Unlike rotors 18 and 24 in FIGS. 1 and 2, however, rotors 30 do not have a flow director such as flow director 17 of FIG. 1. The rotors 30 are each mounted on a shaft 36 (connected to a motor not shown) and reside in a housing 32 having a substantially cylindrical interior surface, an inlet 33 and an outlet 34. Fluid does not enter centrally to the rotor as in FIG. 1, but through inlet 33 somewhat offset from the center of rotor 30. In this case, the fluid in inlet 33 of cavitation device A may contain inorganic coagulants, as an example of a solids/liquid separation enhancing agent, added through conduit 35 to the incoming fluid to be treated. The fluid and coagulant are thoroughly mixed and heated in cavitation device A due to the cavitation phenomenon described above.

The thoroughly mixed fluid, now containing coagulated solids, proceeds through the outlet 34 of cavitation device A and is directed to the inlet 33 of cavitation device B. A conduit 37 connecting with unit B's inlet 33 may introduce a polymeric flocculant, as a further example of a solids/liquid separation enhancing agent, either in dry form or as a viscous solution; this mixture enters cavitation device B, is circulated through the area between the cylindrical surface of rotor 30 and the housing, and then exits through outlet 34 of unit B to conduit 38. The fluid now contains not only coagulated solids by means of the inorganic coagulants introduced through conduit 35, but also flocculated solids by means of the polymeric flocculant added through conduit 37. This mixture is taken to solids/liquid separator 39 which separates the coagulated and flocculated solids with or without a settling tank. As indicated elsewhere, the separator 39 may be a centrifuge or any other effective separator including a filter.

The particular order of addition of coagulants and polymers recited above is not essential—that is, a polymeric flocculant may be introduced in unit A and a coagulant in unit B; also one or more surfactants or filter aids may be introduced separately or along with either the coagulant or the flocculant.

Cavitation devices useful in the invention need not have the exact configuration shown in FIGS. 1, 2, and 3. Nor do I intend to imply that the design of the two cavitation devices illustrated in FIG. 3 cannot be used alone—that is, as used in FIGS. 1 and 2. Any construction having a rotor including cavities moved within a closely conforming surface, together with means for flowing a fluid between the rotor and the surface to cause cavitation will be useful in my invention. Examples include the designs shown in Griggs U.S. Pat. Nos. 5,188,090 and 5,385,298 and Hudson et al U.S. Pat. No. 6,627,784, which are hereby incorporated herein in their entirety. Or, the flow-directed design of U.S. Provisional Patent Application 62/197,862 mentioned above may be used. Also, the dual rotor construction disclosed by the present inventor in U.S. patent application Ser. No. 14/692,278 filed Apr. 21, 2015, also incorporated herein in its entirety, may be used. It should be understood that when connecting the cavitation devices in series or in any other configuration, they may be of somewhat variable construction.

Another useful design for the cavitation device is that of the present inventor's (together with Jeff Fair) U.S. patent application Ser. No. 14/715,160, filed May 18, 2015 titled “Cavitation Pump”; this application is hereby incorporated herein in its entirety. This cavitation device includes a cylindrical rotor as illustrated herein (without a flow director), but also has one or more discs, each having a hole in its center, on the inlet side of the rotor. These rotating discs provide a pumping action to enhance the flow and distribution of the fluid before it contacts the cavitation rotor; they do not impart significant shear or impact such as would a blade or an impeller, and accordingly will not damage the polymers.

Static mixing effects can be contributed by various baffles and in-line obstructions upstream of the cavitation rotor, and these are compatible with the present invention as are even more vigorous, powered mixing parts such as blades, paddles, or impellers, although they are generally not necessary and may damage the polymers. If used downstream of the cavitation rotor, the impact of a blade, paddle, or an impeller also may tend to undo the work of the coagulants and flocculants. My invention utilizes a cavitation rotor with or without such shearing or impacting ancillary mixing on either the inlet side of the outlet side of the rotor.

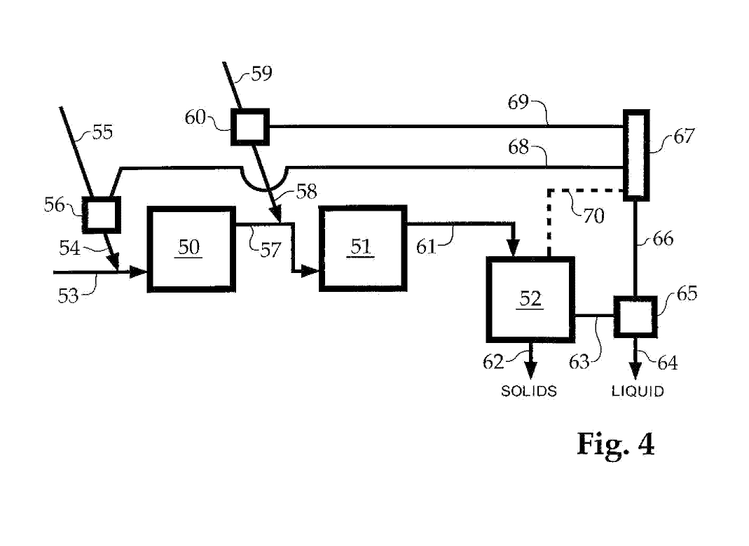

FIG. 4 shows, in simplified form, the use of a feedback control system to regulate the solids/liquid separation process. Cavitation devices 50 and 51 are connected in series as in FIG. 3. Fluid to be mixed, in conduit 53, is injected with coagulant from conduit 54. The coagulant, from a source 55, is delivered by a feeder 56. The fluid/coagulant mixture sent through line 53 is thoroughly mixed and heated in cavitation device 50 as described with respect to FIGS. 1, 2, and 3, and exits to conduit 57 leading to the inlet of cavitation device 51. A polymeric flocculant from source 59 is injected into conduit 57 by feeder 60, passing it through conduit 58. The mixture, now containing both coagulant and polymeric flocculant, is conducted through conduit 57 to the inlet of cavitation device 51, where it is thoroughly mixed and further heated. The fluid, now containing substantial quantities of coagulated and flocculated solids, is passed through conduit 61 to separation device 52, which may be a centrifuge or other solids/liquid separator. Solids are removed through conduit 62 and the liquid is removed through conduits 63 and 64. Between conduits 63 and 64 is a solids monitoring device 65. Solids monitoring device 65 may be, for example, a turbidity meter, a zetameter, or a mass flow meter. Solids monitoring device 65 generates at least one signal as a function of solids (possibly density), suspended or otherwise, in the liquid from conduit 63. The signal, normally an electrical one, is communicated through line 66 to processor/controller 67. Processor/controller 67 reads the signal in line 66 and is programmed to control feeders 56 and/or 60, through electrical or other connections 68 and 69, to vary the feed of coagulant and flocculant to maintain or achieve the desired solids content in the monitored liquid. An optional line 70 connected to separation device 52 may modify the operation of the separation device 52 to further control the process as a function of the liquid effluent or solids removed.

FIG. 4 is a specific example of various possible combinations. In addition to a solids monitoring device 65, a viscometer may be used to control the addition of polymer; the viscometer could be in the position of solids monitoring device 65 or as an additional monitoring device on conduit 63. A viscometer, turbidity meter, mass flow meter, or other monitoring or measuring device may be placed alternatively or in addition, in conduits 57, 58, 61, or 62. Also, the monitoring and control system is not limited to two cavitation devices connected in series—in many situations, only one cavitation device may be sufficient, especially if the control system is able to efficiently control the final solids content in line 63, but also three or more cavitation devices may be connected in series; parallel connections may also be useful in some situations.

The viscometer, solids monitor, or other monitor of a physical characteristic of the liquid effluent from the solids/liquid separator generates a signal as a function of a physical characteristic of the effluent; this signal is used to control the feed of the coagulant or polymer. The cavitation device(s) may or may not include a flow director. Note also that FIG. 4, being a block diagram or flow sheet, does not illustrate the detailed placement of solids monitoring device 65, which may be an in-line continuous device, or located on a conduit parallel to conduit 63/64, or an intermittent sampling device. A viscometer may also be connected in any convenient manner. Likewise, feeders 56 and 60 may comprise any of various valves, pumps and metering devices, as is known in the art of in-field process instrumentation.

In addition to or instead of monitoring turbidity or viscosity in the liquid effluent (as by solids monitoring device 65), the process may be controlled by measuring the mass flow of the fluid entering the cavitation device and also that leaving the centrifuge or other solids/liquid separation device. The addition of solids/liquid separation enhancing agent can be regulated according to the density and rate of semi-solid cake formation and flow of liquid effluent, as determined by mass flow. Mass flow measurement involves the measurement of density, and density is a physical characteristic of the fluid I treat. Hence a mass flow meter generates a signal as a function of density, a physical characteristic of the fluid both before and after the cavitation device and before and after the solids/liquid separation device. As indicated elsewhere herein, monitoring such physical characteristics is a part of my process and can be used to regulate not only the addition of solids/liquid separation enhancing agent, but also the speed of rotation of the cavitation device, the flow rate of the fluid treated, and/or the operation of the liquid/solids separation device.

An inorganic coagulant can be in the form of solids or a suspension. The flocculant, usually a high-molecular weight water-soluble polymer, can be in dry form, or partially hydrated or otherwise in a concentrated solution; it need not be fully dissolved when introduced to the fluid to be treated. As persons skilled in the art are aware, complete solutions of high molecular weight polymers are quire dilute yet impart significant viscosity to the solution.

Many waste treatment and solids separation processes involve the addition of water at one or more points, either alone or as a solvent or carrier for other additives; the addition of water is not necessary with my method, with many benefits which will be apparent to persons skilled in the art. Major objectives of the flocculation treatment of fine fluid tailings, for example, are (1) to remove water trapped in the particles in order to avoid having to find other sources of water for the bitumen extraction process and (2) to accelerate the settling of the solids as an aid in the reclamation process. My invention clearly helps achieve both objectives. My invention is applicable to the processing of any industrial waste water containing solids, including waste fluids containing as little as 5% water and/or fluids containing large amounts of oil.

1. Method of separating solids from a liquid comprising (a) passing a liquid containing solids into a cavitation device, (b) introducing a solids/liquid separation enhancing agent or a combination of solids/liquid separation enhancing agents into said cavitation device, (c) operating said cavitation device to heat and mix said liquid containing solids and said solids/liquid separation enhancing agent or agents to obtain a liquid containing said agent or agents, (d) passing said liquid containing said agent or agents from said cavitation device to a solids/liquids separation device, (e) optionally recycling a portion of said liquid containing said agent or agents to said cavitation device, and (f) separating said solids from said liquids in said separation device.

2. Method of claim 1 wherein said solids/liquid separation enhancing agent or agents comprises a polymeric flocculant.

3. Method of claim 2 wherein said polymeric flocculant is polyacrylamide.

4. Method of claim 1 wherein said cavitation device is a flow-directed cavitation device.

5. Method of claim 1 including monitoring a physical characteristic of the liquid obtained in step (f), generating a signal as a function of said physical characteristic, forwarding said signal to a processor/controller, and controlling the introduction of solids/liquid separation enhancing agent or agents to said cavitation device as a function of said signal.

6. Method of claim 5 including, in addition to or instead of controlling the introduction of said solids/liquid separation enhancing agent or agents, controlling the operation of said solids/liquid separation device.

7. Method of claim 1 wherein said liquid containing solids comprises a used oil field fluid.

8. Method of claim 1 wherein said liquid containing solids comprises mine tailings.

9. Apparatus for removing solids from a liquid containing said solids comprising (a) a cavitation device for mixing and heating said liquid, said cavitation device having an inlet for said liquid and an outlet, (b) a feeder for feeding at least one solids/liquid separation enhancing agent into said liquid at or ahead of said inlet, (c) a solids/liquid separation device connected to receive liquid containing solids and said at least one solids/liquid separation enhancing agent from said outlet, said solids/liquid separation device having a separated solids outlet and a separated liquid outlet, (d) a physical characteristic monitoring device connected to at least one of said separated liquid outlet and said separated solids outlet for monitoring at least one physical characteristic of liquid in said separated liquid outlet or solids in said separated solids outlet, said monitoring device being capable of generating a signal as a function of said at least one physical characteristic, and (e) a processor/controller for receiving said signal and controlling said feeder as a function of said signal.

10. Apparatus of claim 9 wherein said cavitation device comprises a rotor having cavities on its cylindrical surface and a flow director on one side of said rotor, said flow director oriented to receive fluid directly from an inlet.

11. Apparatus of claim 9 wherein said solids/liquid separation device is a centrifuge.

12. Apparatus of claim 9 wherein said physical characteristic monitoring device comprises a turbidity meter.

13. Method of rapidly treating used oil field fluid to separate solids therefrom comprising (a) passing said used oil field fluid through a first cavitation device together with at least one solids/liquid separation enhancing agent to obtain a fluid containing at least one solids/liquid separation enhancing agent, (b) optionally passing said fluid from said first cavitation device through a second cavitation device to obtain a fluid containing at least one additional solids/liquid separation enhancing agent, (c) passing said fluid from at least one of said first or second cavitation device directly to a solids/liquid separation device, and (d) operating said solids/liquid separation device to remove solids from said liquid.

14. Method of claim 13 wherein said solids/liquid separation device comprises a centrifuge.

15. Method of claim 13 wherein said fluid comprises a used fracturing fluid.

16. Method of claim 13 wherein said fluid comprises a used drilling fluid.

17. Method of claim 13 wherein said fluid comprises a produced oil field fluid.

18. Method of claim 13 wherein said used oil field fluid contains at least 5% water by weight and said flocculant comprises a dry polymer.

19. Method of claim 13 wherein at least one of said first and said second non-impinging cavitation device is a flow-directed non-impinging cavitation device.

20. Method of claim 13 including recycling at least some of said fluid containing at least one additional solids/liquid separation enhancing agent obtained in step (b) through at least one of said first and second cavitation devices.
